(19) United States
(12) Patent Application Publication
(10) Pub. No.: US 2016/0085741 A1
(43) Pub. Date: Mar. 24, 2016

(54) ENTITY EXTRACTION FEEDBACK

(71) Applicant: LONGSAND LIMITED, Cambridge, Cambridgeshire (GB)

(72) Inventor: Sean Blanchflower, Cambridge, Cambridgeshire (GB)

(21) Appl. No.: 14/890,537

(22) PCT Filed: May 30, 2013
(86) PCT No.: PCT/EP2013/061198

§ 371 Date: Nov. 11, 2015

(51) Int. Cl. G06F 17/27

(52) U.S. Cl. CPC G06F 17/2725; G06F 17/2785; G06F 17/278

(57) ABSTRACT

Techniques associated with entity extraction feedback are described in various implementations. In one example implementation, a method may include generating a proposed entity extraction result associated with a document, the proposed entity extraction result being generated based on a ruleset applied to the document. The method may also include receiving feedback about the proposed entity extraction result, the feedback including an actual entity associated with the document and a feature of the document that is indicative of the actual entity. The method may also include determining a proposed modification to the ruleset based on the feedback.

### BACKGROUND

Entity extraction is a form of natural language processing that is used to identify which items in a given content source, such as an electronic document, correspond to particular entities. Entity extraction may be used to automatically extract and structure information from semi-structured or unstructured content sources. Examples of entities that may be identified using entity extraction include named entities, such as people or places, as well as other types of entities, such as phone numbers, dates, times, and the like. Entities are often defined using type/value pairs, e.g., Type=Location, Value=Chicago.

Entity extraction may serve as a useful tool in a number of different contexts. For example, in a recruiting scenario, job candidates may provide fairly similar types of information on their respective resumes, but the resumes themselves may be formatted or structured in entirely different manners. In this scenario, entity extraction may be used to identify key pieces of information from the various received resumes (e.g., name, contact information, previous employers, educational institutions, and the like), and such extracted entities may be used to populate a candidate database for use by a recruiter. As another example, entity extraction may be used to monitor radio chatter among suspected terrorists, and to identify and report geographical locations mentioned in such conversations. In this example, such geographical locations may then be analyzed to determine whether they relate to meeting locations, hiding locations, or potential target locations. These examples show just two of the wide-ranging possible uses of entity extraction.

### BRIEF DESCRIPTION OF THE DRAWINGS

FIG. 1 is a conceptual diagram of an example entity extraction environment in accordance with implementations described herein.

FIG. 2 is a flow diagram of an example process for modifying an entity extraction ruleset based on entity extraction feedback in accordance with implementations described herein.

FIG. 3 is a block diagram of an example computing system for processing entity extraction feedback in accordance with implementations described herein.

FIG. 4 is a block diagram of an example system in accordance with implementations described herein.

### DETAILED DESCRIPTION

Many entity extraction systems utilize some form of rules-based models to determine, analyze, and/or extract the entities from a given content source. The rulesets that are defined and applied in a given entity extraction system may be arbitrarily complex, ranging from relatively simplistic to extremely detailed and complicated. The relatively simplistic systems may have rulesets that include a relatively small number of basic rules, while the more sophisticated systems may utilize a significantly higher number of rules and/or significantly more complex rules.

Some entity extraction systems may include rulesets that are generated using one or more elements of machine learning to define certain portions or all of the rules. Such systems are generally intended to cover broader, more complex ranges of entity extraction scenarios. Examples of machine learning approaches that may be applied in the entity extraction context include latent semantic analysis, support vector machines, “bag of words”, and other appropriate techniques or combinations of techniques. Using one or more of these approaches may lead to a fairly robust ruleset, but also one that is fairly complicated to understand and/or maintain.

A common characteristic of any rules-based entity extraction system, regardless of how basic or how complex, is that the systems may only be as accurate as their respective rulesets allow. Accuracy, as the term is used here, may be defined as matching what most human observers would identify as the “correct” or “actual” entity or entities included in a particular content source. Given the variety of types of sources that may be analyzed by entity extraction systems (e.g., web pages, online news sources, Internet discussion groups, online reviews, blogs, social media, and the like), it may often be the case that a particular entity extraction system may exhibit a high level of accuracy when analyzing a particular type of source, but may be less accurate when analyzing a different type of source. In other words, entity extraction systems are often tuned, either intentionally or unintentionally, to work better in a particular context (e.g., understanding resumes) than in others (e.g., monitoring suspected terrorists).

Described herein are techniques for improving the accuracy of rules-based entity extraction systems by providing for more useful and detailed feedback about the entity extraction results that are generated by the respective systems. Rather than simply providing the “correct” entity extraction result in a given situation, the system allows for feedback that identifies the “correct” entities included in the document as well as the feature (or features) of the document that is (or are) indicative of the actual entities. Based on the more detailed feedback, the ruleset of the entity extraction system may be updated in a more targeted manner. The techniques described herein may be used in conjunction with entity extraction systems having relatively simplistic or relatively complex rulesets to improve the accuracy of those systems. These and other possible benefits and advantages will be apparent from the figures and from the description that follows.

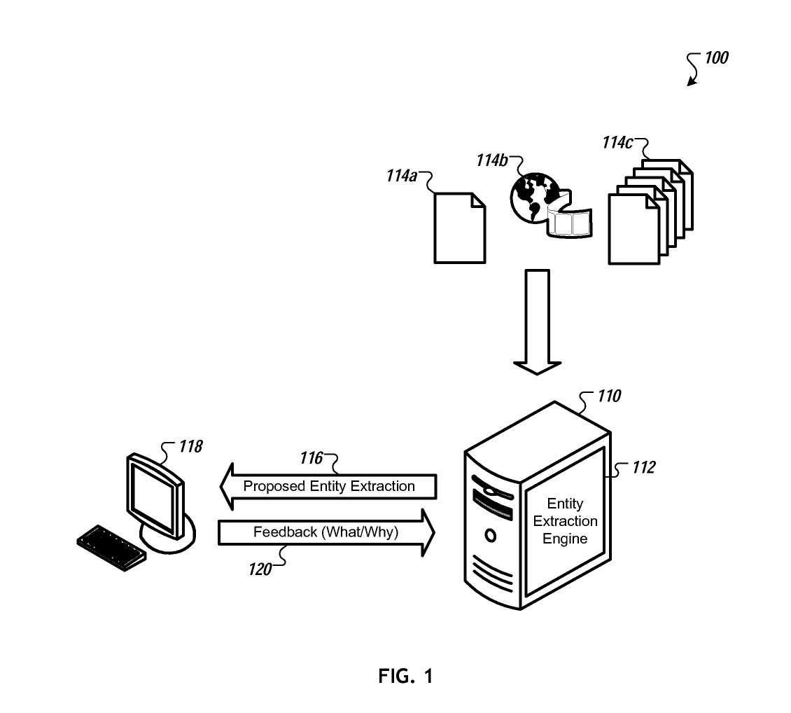

FIG. 1 is a conceptual diagram of an example entity extraction environment 100 in accordance with implementations described herein. As shown, environment 100 includes a computing system 110 that is configured to execute an entity extraction engine 112. The example topology of environment 100 may be representative of various entity extraction environments. However, it should be understood that the example topology of environment 100 is shown for illustrative purposes only, and that various modifications may be made to the configuration. For example, environment 100 may include different or additional components, or the components may be implemented in a different manner than is shown. Also, while computing system 110 is generally illustrated as a standalone server, it should be understood that computing system 110 may, in practice, be any appropriate type of computing device, such as a server, a blade server, a mainframe, a laptop, a desktop, a workstation, or other device. Computing system 110 may also represent a group of computing devices, such as a server farm, a server cluster, or other group of computing devices operating individually or together to perform the functionality described herein.

During runtime, the entity extraction engine 112 may be used to analyze any appropriate type of document, and to generate an entity extraction result that identifies one or more entities extracted from the document. Depending upon the configuration of entity extraction engine 112, the engine may be able to perform entity extraction, for example, on text-based documents 114a, audio, video, or multimedia documents 114b, and/or sets of documents 114c. In the case of audio, video, or multimedia documents 114b, the entity extraction engine 112 may be configured to analyze the documents natively, or may include a “to text” converter (e.g., a speech-to-text transcription module or an image-to-text module) that converts the audio, video, or multimedia portion of the document into text for a text-based entity extraction. The entity extraction engine 112 may also be configured to perform entity extraction on other appropriate types of documents, either with or without “to text” conversion.

The entity extraction result generated by the entity extraction engine 112 may generally include the entity type and entity value (e.g., type=location; value=Chicago). The entity extraction result may also include other information. For example, the entity extraction result may include one or more particular rules that were implicated in extracting the entity from the document. Such implicated rules, which may also be referred to as triggered rules, may help to explain why a particular entity was identified. As another example, the entity extraction result may include the specific portion or section of the document from which the entity was extracted. As another example, the entity extraction result may include multiple entities associated with different portions of a document, and may also include the respective portions of the document from which each of the respective entities were extracted.

The entity extraction result may be used in different ways, depending on the implementation. For example, in some cases, the entity extraction result may be used to tag the document (e.g., by using a metadata tagging module) after it has been analyzed, such that the metadata of the document contains the entity or entities associated with the document. The entity extraction result may also be used for indexing purposes. In other cases, the entity extraction result or portions thereof may simply be returned to a user or stored in a structured format, such as in a database. For example, the user may provide a document to the entity extraction engine 112, and the various entities identified in the document may be returned to the user, e.g., via a user interface such as a display, or may be stored in a database of structured information. Other appropriate runtime uses for the entity extraction result may also be implemented.

The runtime scenarios described above generally operate by the entity extraction engine 112 applying a pre-existing ruleset to an input document to generate an entity extraction result, without regard for whether the entity extraction result is accurate or not. The remainder of this description generally relates to entity extraction training scenarios using the entity extraction feedback techniques described herein to improve the accuracy of the entity extraction system. However, in some cases, all or portions of the entity extraction training scenarios may also be implemented during runtime to continuously fine-tune the system's ruleset. For example, end users of the entity extraction system may provide information similar to that of users who are explicitly involved in training the system (as described below), and such end user-provided information may be used to improve the accuracy of entity extraction in a similar manner as such improvements that are based on trainer feedback. In various implementations, end user feedback may be provided either explicitly (e.g., in a manner similar to trainer feedback), implicitly (e.g., by analyzing end user behaviors associated with the entity extraction result, such as click-through or other indirect behaviors), or an appropriate combination thereof.

During explicit system training scenarios, the entity extraction engine 112 may operate similarly to the runtime scenarios described above. For example, entity extraction engine 112 may analyze an input document, and may generate an entity extraction result associated with the document that identifies one or more entities from the document. However, rather than being an absolute entity result, the entity extraction result in the training scenario may be considered a proposed entity extraction result. A proposed entity extraction result that matches the trainer's determination of an actual entity included in the document may be used to reinforce certain rules as being applicable to different use cases, while a proposed entity extraction result that does not match the trainer's determination of an actual entity may indicate that the ruleset is incomplete, or that certain rules may be defined incorrectly (e.g., as over-inclusive, under-inclusive, or both).

The proposed entity extraction result may generally include the entity (e.g., a type/value pairing) or entities extracted from the document. The proposed entity extraction result may also include other information. For example, the proposed entity extraction result may include one or more particular rules (e.g., triggered rules) that were implicated in identifying the entity associated with the document. As another example, the proposed entity extraction result may include the specific portion of the document from which the entity was extracted. As another example, the proposed entity extraction result may include multiple proposed entities associated with different portions of a document, and the respective portions of the document from which those proposed entities were extracted. As another example, the proposed entity extraction result may include specific dictionary words that were identified while determining the entity. As another example, the proposed entity extraction result may include a specific topic that was identified as being discussed with a particular entity. It should be understood that the entity extraction result may also include combinations of these or other appropriate types of information.

The proposed entity extraction result may be provided (e.g., as shown by arrow 116) to a trainer, such as a system administrator or other appropriate user. For example, the entity extraction result may be displayed on a user interface of a computing device 118. The trainer may then provide feedback back to the entity extraction engine 112 (e.g., as shown by arrow 120) about the proposed entity extraction result. The feedback may be provided, for example, via the user interface of computing device 118.

The feedback about the proposed entity extraction result may include the actual entity included in the document as well as the feature (or features) of the document that is (or are) indicative of the actual entity. For example, the trainer may identify the correct entity included in the document and the particular feature that is most indicative of the correct entity, and may provide such feedback to the entity extraction engine 112. Based on the more detailed feedback that includes the “what” and the “why” associated with the actual entity (rather than just identifying what the actual entity is), the entity extraction engine 112 may update its ruleset in a more targeted manner.

For example, consider an entity extraction system that is provided a document about the success of certain reading programs in the state of Pennsylvania. Depending on how the ruleset of the entity extraction system is implemented, the system may identify Reading (a city in southeastern Pennsylvania) as a location-type entity included in the document even though the story does not actually include reference to the city of Reading. A number of possible rules may provide such an incorrect result—e.g., in documents where a state is mentioned, check for city names in that state that are also mentioned in the document; or, in documents where a state is mentioned, identify capitalized terms and determine if those terms correspond to cities in that state. These rules may work under certain circumstances, but may both lead to a false-positive identification of Reading as an entity in this scenario. For example, the second possible rule would be triggered if the term “reading” started a sentence, and was therefore capitalized, even though it was not used as a capitalized proper noun as the rule is intended to capture. In this case, the proposed entity (determined by the system to be the city of Reading) would be different from an actual entity as determined by the trainer.

In such a case, simply feeding back that the system got it wrong, e.g., that the city of Reading is not an entity included in the document, may prove to be somewhat useful to the system (which may then update its entity extraction result for that particular document), but may not be as useful to the system in terms of identifying an updated rule (or rules) that would more accurately extract (or know not to extract) the entity in other similar documents. As such, in accordance with the techniques described here, the trainer may also identify the feature of the document that is indicative of the actual entity or lack of an actual entity in this case, e.g., by indicating that the term Reading was only capitalized because it began a sentence as opposed to being a proper noun. Based on the feedback, the entity extraction ruleset may be updated in a targeted manner, e.g., by implementing a rule that looks for other instances of the term in the document and not attributing the term as a proper noun if it is only capitalized at the beginning of a sentence, or by otherwise adjusting the ruleset so that an accurate result is achieved. In some cases, different modifications to the ruleset may be proposed and/or tested to determine the most comprehensive or best fit adjustments to the system.

Other updates to the entity extraction ruleset may similarly be based on where particular terms or phrases are located within a particular document or with respect to other terms (e.g., ambiguous possible entities located within a few words of a known indicator of such an entity). Similarly, other rules may be updated based on feedback about the content (e.g., text) of the document itself. For example, the trainer may identify a particular phrase or other textual usage that was mishandled by a rule in the ruleset, and may point to that text in the document as being indicative of the actual entity of the document.

The text-based examples described above are relatively simplistic and are used to illustrate the basic operation of the entity extraction feedback system, but it should be understood that the feedback mechanism may also be used in more complex scenarios. For example, the feedback mechanism may allow the trainer to identify more complex language patterns or contexts, such as by identifying various linguistic aspects, including prefixes, suffixes, keywords, phrasal usage, and the like. By identifying specific instances of such language patterns and/or contexts, the entity extraction system may be trained to identify similar patterns and/or contexts, and to analyze them accordingly, e.g., by implementing additional or modified rules in the ruleset.

In addition to text-based features present in the content of the document, the trainer may also provide feedback that identifies a classification associated with the document as another feature that is indicative of actual entity. The classification associated with a document may include any appropriate classifier, such as the conceptual topic of the document, the type of content being examined, and/or the document context, as well as other classifiers that may be associated with the document, such as author, language, publication date, source, or the like. These classifiers may be indicative of the actual entity of the document, e.g., by providing a context in which to apply the linguistic rules associated with the text and/or other content of the document.

In some implementations, the trainer may provide feedback that includes both a selected portion of the document as well as a classification associated with the document, both of which or a combination of which are indicative of the actual entity included in the document. Based upon such feedback, the entity extraction system may be updated to identify similar phrasal usages in a particular context, and to determine the correct entity accordingly, e.g., by implementing additional or modified rules in the ruleset.

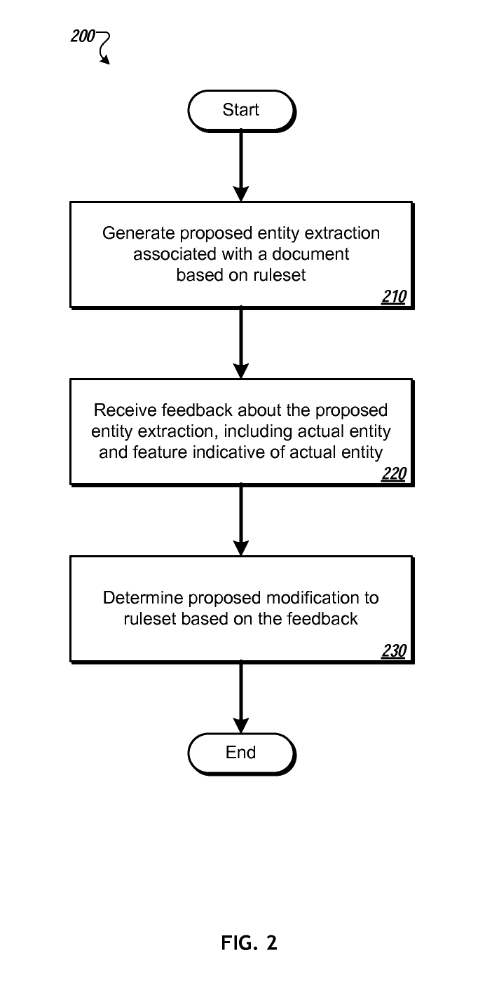

FIG. 2 is a flow diagram of an example process 200 for modifying an entity extraction ruleset based on entity extraction feedback in accordance with implementations described herein. The process 200 may be performed, for example, by an entity extraction engine such as the entity extraction engine 112 illustrated in FIG. 1. For clarity of presentation, the description that follows uses the entity extraction engine 112 illustrated in FIG. 1 as the basis of an example for describing the process. However, it should be understood that another system, or combination of systems, may be used to perform the process or various portions of the process.

Process 200 begins at block 210, in which a proposed entity extraction result associated with a document is generated based on a ruleset applied to the document. For example, entity extraction engine 112 may identify a proposed entity included in a particular document based on a ruleset implemented by the engine.

In some cases, entity extraction engine 112 may also identify one or more triggered rules from the ruleset that affect the proposed entity extraction result, and may cause the triggered rules to be displayed to a user. Continuing with the “Reading” example above, the one or more triggered rules that suggested Reading as a city entity may be identified. In cases where multiple rules are triggered in generating the proposed entity extraction result, each of the rules may be displayed to the user. Such information may assist the user in understanding why a particular entity extraction result was generated. In some cases, the number of triggered rules may be quite numerous, and so the entity extraction engine 112 may instead only display higher-order rules that were triggered in generating the proposed entity extraction result. In some implementations, the user may also be allowed to drill down into the higher-order rules to see additional lower-order rules that also affected the proposed entity extraction result as necessary.

At block 220, feedback about the proposed entity extraction result is received. The feedback may include an actual entity (or lack of an entity) associated with the document and a feature of the document that is indicative of the actual entity. For example, entity extraction engine 112 may receive (e.g., from a trainer or from another appropriate user) feedback that identifies the actual entity of the document as well as the feature of the document that is most indicative of the actual entity. In some implementations, the feature of the document that is indicative of the actual entity may include a portion of content from the document (e.g., a selection from the document that is most indicative of the actual entity). In some implementations, the feature of the document that is indicative of the actual entity may include a classification associated with the document (e.g., a conceptual topic or language associated with the document). In some implementations, the feedback may include both a selected portion of the document as well as a classification associated with the document, both of which or a combination of which are indicative of the actual entity of the document.

At block 230, a proposed modification to the ruleset is identified based on the received feedback. For example, entity extraction engine 112 may identify a new rule or a change to an existing rule in the ruleset based on the feedback identifying the features of the document that are most indicative of the actual entity (or lack of an entity) included in the document.

In the case of a change to an existing rule, entity extraction engine 112 may determine, based on the feedback, that one or more existing rules that were triggered during the generation of the proposed entity extraction result were defined incorrectly (e.g., under-inclusive, over-inclusive, or both) if the proposed entity extraction result does not match the actual entity. In such a case, the entity extraction engine 112 may identify a proposed modification to one or more of the triggered rules based on the feature identified in the feedback. In some cases, the triggered rule and the proposed change to the triggered rule may be displayed to the user.

In the case of a new rule, entity extraction engine 112 may determine, based on the feedback, that the feature of the document identified as being indicative of the actual entity was not used when generating the proposed entity extraction result (e.g., when the engine 112 fails to identify an entity in the document), which may indicate that the ruleset does not include an appropriate rule to capture the specific scenario present in the document being analyzed. In such a case, the entity extraction engine 112 may identify a new proposed rule to be added to the ruleset based on the feature identified in the feedback.

In some cases, entity extraction engine 112 may also cause the proposed modification to the ruleset (either a new rule or a change to an existing rule) to be displayed to a user, and may require verification from the user that such a proposed modification to the ruleset is acceptable. For example, the entity extraction engine 112 may cause the proposed modification to be displayed to the trainer who provided the feedback, and may only apply the proposed change to the ruleset in response to receiving a confirmation of the proposed change by the user.

In some implementations, entity extraction engine 112 may also identify other known documents (e.g., from a corpus of previously-analyzed documents) that would have been analyzed similarly or differently based on the proposed modification to the ruleset. In such implementations, a notification may be displayed to the user indicating the documents that would have been analyzed similarly or differently, e.g., so that the user can understand the potential ramifications of applying such a modification. By identifying documents that might be affected by the proposed modification to the ruleset, the system may help prevent the situation where new entity extraction problems are created when others are fixed.

In some cases, different modifications to the ruleset may be proposed and/or tested to determine the most comprehensive or best fit adjustments to the system. For example, entity extraction engine 112 may identify multiple possible modifications to the ruleset, each of which would reach the “correct” entity extraction result and which would also satisfy the constraints of the feedback. In such cases, the entity extraction engine 112 may discard as a possible modification any modification that would adversely affect the “correct” entity of a previously analyzed document.

FIG. 3 is a block diagram of an example computing system 300 for processing entity extraction feedback in accordance with implementations described herein. Computing system 300 may, in some implementations, be used to perform certain portions or all of the functionality described above with respect to computing system 110 of FIG. 1, and/or to perform certain portions or all of process 200 illustrated in FIG. 2.

Computing system 300 may include a processor 310, a memory 320, an interface 330, an entity extraction analyzer 340, a rule updater 350, and an analysis rules and data repository 360. It should be understood that the components shown here are for illustrative purposes only, and that in some cases, the functionality being described with respect to a particular component may be performed by one or more different or additional components. Similarly, it should be understood that portions or all of the functionality may be combined into fewer components than are shown.

Processor 310 may be configured to process instructions for execution by computing system 300. The instructions may be stored on a non-transitory, tangible computer-readable storage medium, such as in memory 320 or on a separate storage device (not shown), or on any other type of volatile or non-volatile memory that stores instructions to cause a programmable processor to perform the techniques described herein. Alternatively or additionally, computing system 300 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

Interface 330 may be implemented in hardware and/or software, and may be configured, for example, to provide entity extraction results and to receive and respond to feedback provided by one or more users. For example, interface 330 may be configured to receive or locate a document or set of documents to be analyzed, to provide a proposed entity extraction result (or set of entity extraction results) to a trainer, and to receive and respond to feedback provided by the trainer. Interface 330 may also include one or more user interfaces that allow a user (e.g., a trainer or system administrator) to interact directly with the computing system 300, e.g., to manually define or modify rules in a ruleset, which may be stored in the analysis rules and data repository 360. Example user interfaces may include touchscreen devices, pointing devices, keyboards, voice input interfaces, visual input interfaces, or the like.

Entity extraction analyzer 340 may execute on one or more processors, e.g., processor 310, and may analyze a document using the ruleset stored in the analysis rules and data repository 360 to determine a proposed entity extraction result associated with the document. For example, the entity extraction analyzer 340 may parse a document to determine the terms and phrases included in the document, the structure of the document, and other relevant information associated with the document. Entity extraction analyzer 340 may then apply any applicable rules from the entity extraction ruleset to the parsed document to determine the proposed entity extraction result. After determining the proposed entity extraction result using entity extraction analyzer 340, the proposed entity may be provided to a user for review and feedback, e.g., via interface 330.

Rule updater 350 may execute on one or more processors, e.g., processor 310, and may receive feedback about the proposed entity extraction result. The feedback may include an actual entity associated with the document, e.g., as determined by a user. The feedback may also include a feature of the document that is indicative (e.g., most indicative) of the actual entity. For example, the user may identify a particular feature (e.g., a particular phrasal or other linguistic usage, a particularly relevant section of the document, or a particular classification of the document), or some combination of features, that supports the user's assessment of actual entity.

In response to receiving the feedback, rule updater 350 may identify a proposed modification to the ruleset based on the feedback as described above. For example, rule updater 350 may suggest adding one or more new rules to cover a use case that had not previously been defined in the ruleset, or may suggest modifying one or more existing rules in the ruleset to correct or improve upon the existing rules.

Analysis rules and data repository 360 may be configured to store the entity extraction ruleset that is used by entity extraction analyzer 340. In addition to the ruleset, the repository 360 may also store other data, such as information about previously analyzed documents and their corresponding “correct” entities. By storing such information about previously analyzed documents, the computing system 300 may ensure that proposed modifications to the ruleset do not impinge upon previously analyzed documents. For example, rule updater 350 may identify multiple proposed modifications to the ruleset that may fix an incorrect entity extraction result, some of which would implement broader changes to the ruleset than others. If rule updater 350 determines that one of the proposed modifications would adversely affect the “correct” entity of a previously analyzed document, updater 350 may discard that proposed modification as a possibility, and may instead only propose modifications that are narrower in scope, and that would not adversely affect the proposed entity of a previously analyzed document.

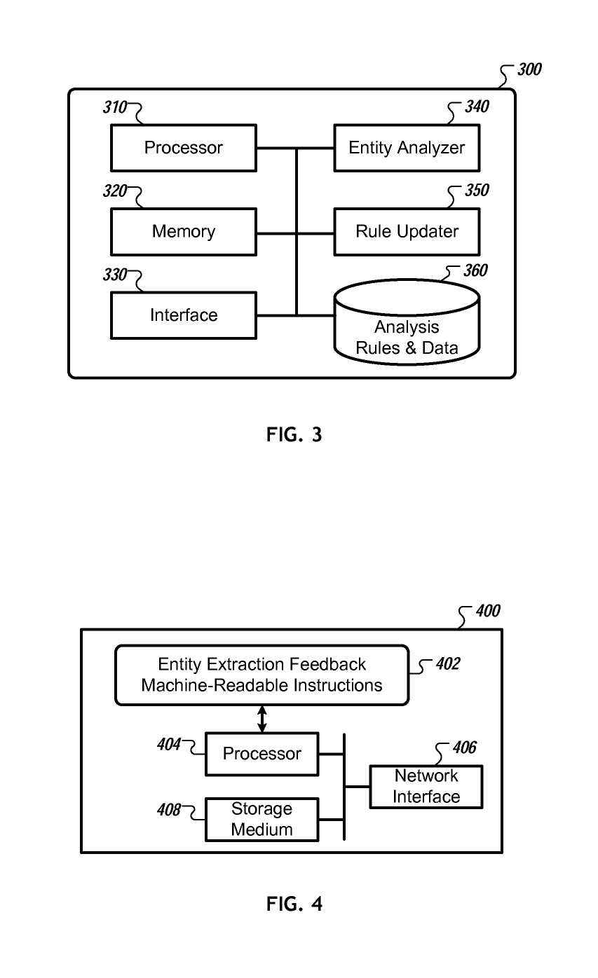

FIG. 4 shows a block diagram of an example system 400 in accordance with implementations described herein. The system 400 includes entity extraction feedback machine-readable instructions 402, which may include certain of the various modules of the computing devices depicted in FIGS. 1 and 3. The entity extraction feedback machine-readable instructions 402 may be loaded for execution on a processor or processors 404. As used herein, a processor may include a microprocessor, microcontroller, processor module or subsystem, programmable integrated circuit, programmable gate array, or another control or computing device. The processor(s) 404 may be coupled to a network interface 406 (to allow the system 400 to perform communications over a data network) and/or to a storage medium (or storage media) 408.

The storage medium 408 may be implemented as one or multiple computer-readable or machine-readable storage media. The storage media may include different forms of memory including semiconductor memory devices such as dynamic or static random access memories (DRAMs or SRAMs), erasable and programmable read-only memories (EPROMs), electrically erasable and programmable read-only memories (EEPROMs), and flash memories; magnetic disks such as fixed, floppy and removable disks; other magnetic media including tape; optical media such as compact disks (CDs) or digital video disks (DVDs); or other appropriate types of storage devices.

Note that the instructions discussed above may be provided on one computer-readable or machine-readable storage medium, or alternatively, may be provided on multiple computer-readable or machine-readable storage media distributed in a system having plural nodes. Such computer-readable or machine-readable storage medium or media is (are) considered to be part of an article (or article of manufacture). An article or article of manufacture may refer to any appropriate manufactured component or multiple components. The storage medium or media may be located either in the machine running the machine-readable instructions, or located at a remote site, e.g., from which the machine-readable instructions may be downloaded over a network for execution.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

What is claimed is:

1. A computer-implemented method of processing entity extraction feedback, the method comprising:
generating, with a computing system, a proposed entity extraction result associated with a document, the proposed entity extraction result being generated based on a ruleset applied to the document;
receiving, with the computing system, feedback about the proposed entity extraction result, the feedback including an actual entity included in the document and a feature of the document that is indicative of the actual entity; and
determining, with the computing system, a proposed modification to the ruleset based on the feedback.

2. The computer-implemented method of claim 1, further comprising causing the proposed modification to the ruleset to be displayed to a user, and applying the proposed modification to the ruleset in response to receiving a confirmation by the user.

3. The computer-implemented method of claim 1, wherein the feature of the document that is indicative of the actual entity comprises a portion of content from the document.

4. The computer-implemented method of claim 1, wherein the feature of the document that is indicative of the actual entity comprises a classification associated with the document.

5. The computer-implemented method of claim 1, wherein determining the proposed modification to the ruleset comprises identifying a triggered rule from the ruleset that affects the proposed entity extraction result, and generating a proposed change to the triggered rule when the proposed entity extraction result does not match the actual entity, the proposed change to the triggered rule being generated based on the feature of the document that is indicative of the actual entity.

6. The computer-implemented method of claim 5, further comprising causing the triggered rule and the proposed change to the triggered rule to be displayed to a user.

7. The computer-implemented method of claim 1, wherein generating the proposed modification to the ruleset comprises determining a new proposed rule to be added to the ruleset, the new proposed rule being based on the feature of the document that is indicative of the actual entity.

8. The computer-implemented method of claim 1, further comprising identifying a triggered rule from the ruleset that affects the proposed entity extraction result, and causing the triggered rule to be displayed to a user.

9. The computer-implemented method of claim 1, further comprising identifying other documents, from a corpus of previously-analyzed documents, that would be affected by the proposed modification to the ruleset, and causing a notification to be displayed to a user, the notification indicating the other documents.

10. An entity extraction feedback system comprising:
one or more processors;
an entity extraction analyzer, executing on at least one of the one or more processors, that analyzes a document using a ruleset to determine a proposed entity extraction result associated with the document; and
a rule updater, executing on at least one of the one or more processors, that receives feedback about the proposed entity extraction result, the feedback including an actual entity associated with the document and a feature of the document that is indicative of the actual entity, and generates a proposed modification to the ruleset based on the feedback.

11. The entity extraction feedback system of claim 10, wherein the rule updater causes the proposed modification to the ruleset to be displayed to a user, and updates the ruleset with the proposed modification in response to receiving a confirmation by the user.

12. The entity extraction feedback system of claim 10, wherein the rule updater generates the proposed modification to the ruleset by identifying a triggered rule from the ruleset that affects the proposed entity extraction result, and generating a proposed update to the triggered rule when the proposed entity extraction result does not match the actual entity, the proposed update to the triggered rule being generated based on the feature of the document that is indicative of the actual entity.

13. The entity extraction feedback system of claim 12, wherein the rule updater causes the triggered rule and the proposed update to the triggered rule to be displayed to a user.

14. The entity extraction feedback system of claim 10, wherein the rule updater generates the proposed modification to the ruleset by generating a new proposed rule to be added to the ruleset, the new proposed rule being based on the feature of the document that is indicative of the actual entity.

15. A non-transitory computer-readable storage medium storing instructions that, when executed by one or more processors, cause the one or more processors to:
generate a proposed entity extraction result associated with a document, the proposed entity extraction result being generated based on a ruleset applied to the document;
receive feedback about the proposed entity extraction result, the feedback including an actual entity associated with the document and a classification associated with the document; and
determine a proposed modification to the ruleset based on the feedback.
